(19) United States
(12) Patent Application Publication
(10) Pub. No.: US 2008/0293902 A1
(43) Pub. Date: Nov. 27, 2008

(54) MERCAPTAN MIXTURE

(75) Inventors: Werner Obrecht, Moers (DE); Stephen Pask, Dormagen (DE); Wilfried Kohler, Bergisch Gladbach (DE); Michael Klimpel, Strasbourg (FR)

Correspondence Address: LANXESS CORPORATION, 111 RIDC PARK WEST DRIVE, PITTSBURGH, PA, 15275-1112, US

(73) Assignee: LANXESS Deutschland GmbH, Leverkusen (DE)

(21) Appl. No.: 12/030,971

(22) Filed: Feb. 14, 2008

(30) Foreign Application Priority Data
May 22, 2007 (DE) 102007024009.2

(51) Int. Cl. C08F 20/44; C09K 3/00

(52) U.S. Cl. 526/224; 252/182.17; 526/341

(57) ABSTRACT

A novel mixture containing a number of particular mercaptans, a process for preparing it and its use as advantageous molecular weight regulator in the production of synthetic rubbers are provided.

### FIELD OF THE INVENTION

The invention relates to a mixture containing various mercaptans, a process for preparing it and its use as molecular weight regulator in the production of synthetic rubbers.

### BACKGROUND OF THE INVENTION

Mercaptans are used for regulating the molecular weight in free-radical polymerization reactions. This use is possible regardless of whether the polymerization is carried out in bulk, in suspension, in solution or in emulsion.

The use of dodecyl mercaptans is important for regulating the molecular weight of emulsion rubbers based on monomers such as styrene, butadiene, acrylonitrile, (meth)acrylic acid, fumaric acid, ethyl acrylate, butyl acrylate, 2-ethylhexyl acrylate, chloroprene and others.

U.S. Pat. No. 2,434,536 states that synthetic rubbers based on diolefins such as butadiene and if appropriate further copolymerizable monomers such as styrene, α-methylstyrene, vinylnaphthalene, acrylonitrile, methacrylonitrile, methyl methacrylate, ethyl fumarate or methyl vinyl ketone are produced by emulsion polymerization in the presence of aliphatic mercaptans as molecular weight regulators. It is disclosed that these mercaptans have at least 7 and preferably 10 or more carbon atoms. Preference is given to using aliphatic mercaptans which have an average molecular weight of from 188 to 230 and comprise at least 50% of dodecyl mercaptan and the balance to 100% in the form of mercaptans having from 10 to 16 carbon atoms.

It is stated in general terms in Ullmanns Enzykiopädie der technischen Chemie, 4th edition, volume 13, pages 611-612, that the molecular weight of nitrile-butadiene rubbers can be regulated by the use of alkyl mercaptans, disulphides and polysulphides or xanthogen disulphides. Here, tert-dodecyl mercapta and diisopropylxanthogen disulphides are said to be the regulators which are mainly used.

tert-Dodecyl mercaptan is usually prepared by acid-catalyzed addition of hydrogen sulphide onto olefins having 12 carbon atoms. C₁₂-Olefin starting materials (also referred to as “C₁₂ feedstocks”) which are predominantly used are oligomer mixtures based on tetramerized propene (also referred to as “tetrapropene” or “tetrapropylene”), trimerized isobutene (also referred to as “triisobutene” or “triisobutylene”), trimerized n-butene and dimerized hexene.

Chimie & Industrie, Vol 90 (1963), No 4, 358-368, describes the prior art for the preparation of mercaptans tip to 1962. Apart from the synthesis of mercaptans from alcohols, the addition of hydrogen sulphide onto olefins plays an important role, especially in the United States. Temperatures of from 0° C. to +100° C. have been employed for the catalyzed addition of hydrogen sulphide. The greatest disadvantage of these processes is the loss in yield due to oligomerization of the olefin. In particular, a process for preparing tert-dodecyl mercaptan from tetrapropene and hydrogen sulphide at −40° C. in the presence of boron trifluoride or aluminium trichloride as catalyst is described.

Various reaction conditions are mentioned in the literature for the preparation of a mercaptan mixture by addition of hydrogen sulphide using a triisobutene feedstock (TIB).

U.S. Pat. No. 2,531,602 describes the addition of compounds of the H—SR type, where R is hydrogen or an organic radical, onto various olefins and olefin feedstocks. As regards the reaction mechanism, it is stated that the addition proceeds according to Markownikoff's rule in the absence of peroxides and other substances which form free radicals and the radical —SR is bound to the carbon atom having the largest number of alkyl substituents. In this way secondary mercaptans or secondary thioethers are obtained from linear olefins and tertiary mercaptans or tertiary thioethers are obtained from branched olefins. However, since the unsaturated starting materials frequently contain peroxides, it is stated that an addition of hydrogen sulphide counter to Markownikoff's rule is to be expected. U.S. Pat. No. 2,531,602 states that the mercaptans and thioethers expected according to Markownikoff's rule can also be obtained without the peroxides having to be removed from the olefins; for his purpose, the reaction is carried out at mild temperatures and in the presence of water-free catalysts, preferably anhydrous aluminium chloride. However the yields obtained are not satisfactory: in example III, tert-dodecyl mercaptan is obtained in a yield of only 50% after a reaction time of 0.25 h at an average temperature of −23° C. when using 1.57 mol % (corresponding to 1.25% by weight) of AlCl₃, based on TIB. It may be assumed on the basis of the acid catalysis that rearrangement of the double bond and of the carbon skeleton can also occur during the addition, so that the addition of the —SR radical can also occur at a different place in the molecule than would be expected from the original position of he double bond. Since this addition reaction is reversible, the addition reaction can be followed by a sequence of elimination and rearrangement reactions which lead to migration of the double bond. If hydrogen sulphide is used, the formation of thioethers is also possible as a result of its bifunctionality. Analytical characterization of the tert-dodecyl mercaptan obtained in Example III of U.S. Pat. No. 2,531,602 is not carried out.

DD 137 307 describes the addition reaction of hydrogen sulphide onto a pure tertiary aliphatic olefin or onto isomer mixtures at from 10 to 50° C. using liquid complexes of aluminium chloride with aromatic ethers such as anisole and/or phenetole, or solutions thereof as catalysts. However, these complexes are disadvantageous to use when aromatic solvents such as toluene or benzene are used. Reaction of triisobutene with hydrogen sulphide in the presence of the AlCl₃-anisole or AlCl₃-phenetole complex as catalyst (AlCl₃ amounts of from 0.9 to 2.14% by weight based on triisobutene) at temperatures of from 10° C. to 50° C. with further introduction of hydrogen sulphide gives yields of from 91 to 96% of tert-dodecyl mercaptan. Disadvantages of the process are thus relatively long reaction times of about 30 minutes and the use of aromatic solvents such as toluene or benzene or of ethers. In addition, it is not possible to discern the isomer composition of the mercaptan mixture formed and whether this is suitable as molecular weight regulator for the production of rubbers, in particular nitrile rubber.

According to DD 160 222, the addition of hydrogen sulphide onto tertiary olefins is carried out in the presence of a liquid complex of AlCl₃ with alkylaromatics and hydrochloric acid, preferably toluene and/or ethylbenzene and/or diethylbenzene. In the examples, triisobutene is reacted with hydrogen sulphide in the temperature range 10-50° C. using a complex salt solution of AlCl₃/toluene/HCl (molar ratio=1:3:0.6) as catalyst. When from 0.31 to 0.83% by weight of AlCl₃ based on triisobutene is used, yields of tert-dodecyl mercaptan in the range from 91 to 93% are obtained after 30 minutes. The disadvantages of the process are thus also the relatively long reaction times and the use of aromatic solvents such as toluene. Furthermore, DD 160 222 also gives no information on the isomer distribution in the tert-dodecyl mercaptan mixture. No mention is made of a potential use as molecular weight regulator, either.

According to U.S. Pat. No. 3,137,735, the addition of hydrogen sulphide onto triisobutene is carried out at temperatures of from −90° F. to 0° F. in a continuous process using a complex of BF₃ with H₃PO₄ and an alcohol, preferably methanol. The critical disadvantage of the process is its very low TIB conversion in the range from 9 to not more than 25 mol % per reaction cycle. It is not possible to discern the composition of the mercaptan mixture formed.

According to SU 518 489, ethylaluminium dichloride in isopentane is used as catalyst. Disadvantages of the process are the large quantities of catalyst and the use of solvents. Nothing is disclosed about the composition of the tertdodecyl mercaptan mixture and its usability as molecular weight regulator.

According to WO-A-2005/1082846, the reaction of trimerized n-butene with hydrogen sulphide is carried out continuously at temperatures of from 10 to 250° C., preferably from 50 to 150° C., at a pressure of 15 bar using a variety of catalysts, with a feedstock fraction having a narrow boiling range being selected. As catalysts, preference is given to using polymer-bonded acids such as acidic cation exchange resins. The effect of the mercaptan mixture prepared in this way is demonstrated in the preparation of styrene-butadiene copolymers. A disadvantage of the process is the loss in yield due to the use of a trimerized n-butene feedstock having a narrow boiling range. The mercaptan mixture is not defined structurally in any way but is characterized exclusively by the boiling point behaviour.

According to GB 823,824, the addition of hydrogen sulphide onto various olefin feedstocks is carried out batchwise at from 0 to 5° C. in the presence of a BF₃-methanol adduct as catalyst, with further hydrogen sulphide being fed in. Suitable olefin feedstocks are tetrapropene and triisobutene. When triisobutene is used as olefin feedstock, a crude mercaptan mixture having a tert-dodecyl mercaptan content of 38% is obtained. Disadvantages of the process are the low yields of tert-dodecyl mercaptan and extremely long reaction times of up to 20 hours. No information is given on the isomer distribution in the tertdodecyl mercaptan mixture obtained. The disclosure of GB 823,823 differs from that of GB 823,824 in the use of a catalyst based on a BF₃ adduct with diethyl ether. Tetrapropene and triisobutene are again suitable as olefin feedstock. When triisobutene is used as olefin feedstock, a crude mercaptan mixture having a tert-dodecyl mercaptan content of 49% is obtained according to the teachings of GB 823,823. The yield of tert-dodecyl mercaptan is thus too low for industrial use of the process. The reaction times of up to 20 hours are once again not acceptable.

JP 07-316126, JP 07-316127, JP 07-316128 describe further variants of the addition of hydrogen sulphide onto a triisobutene feedstock comprising 2-(2,2-dimethylpropane)-4,4-dimethyl-1-pentene and/or 2,2,4,6,6-pentamethyl-3-heptene. All processes have the common objective of preparing the specific tert-dodecyl mercaptan isomer 2,2,4,6,6-pentamethylheptane-4-thiol in high purity.

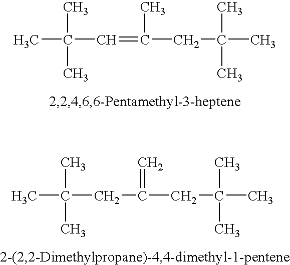

According to JP 07-316126, the reaction of the abovementioned triisobutene feedstock, in which the two isomers specified can be present in any ratio to one another, with hydrogen sulphide is carried out under superatmospheric pressure in the presence of acids as catalyst, with the reaction being stopped by means of a stopping reagent such as sodium carbonate before the reaction mixture is brought to atmospheric pressure. As acids, it is possible to use protic acids or Lewis acids, preferably BF₃ or a complex based on BF₃. In the examples, reaction of triisobutene having the abovementioned composition in the presence of a BF₃ adduct at a reaction pressure in the range from 5 to 10 bar gives a yield of from 54 to 62% of 2,2,4,6,6-pentamethylheptane-4-thiol, with from 35 to 40% of triisobutene remaining unreacted in each case. A substantial disadvantage is long reaction times in the range from 2 to 6 hours.

According to JP 07-316127, the addition of hydrogen sulphide is carried out in the presence of a carboxylic acid adduct of BF₃. The triisobutene feedstock comprises 50-100% of 2-(2,2-dimethylpropane)-4,4-dimethyl-1-pentene and possibly up to 50% of 2,2,4,6,6-pentamethyl-3-heptene in this case. This ratio of the two isomers relative to one another is said to be essential to obtain 2,2,4,6,6-pentamethylheptane-4-thiol in yields of from 56 to 61% in the presence of the carboxylic acid adduct of BF₃. Once again, from 33 to 40% of the triisobutene feedstock remains unreacted. The reaction times of this process are also substantially too long and are in the range from 2 to 6 hours.

According to JP 07-316128, the addition of hydrogen sulphide onto a triisobutene feedstock contaminated with Lewis bases is carried out in the presence of a protic acid and a Lewis acid. In the specific triisobutene feedstock contaminated with Lewis bases, the two above-mentioned isomers can be present in any ratio to one another. It is obtained by recovery from a first hydrogen sulphide addition cycle in which a triisobutene feedstock which is initially free of Lewis bases is reacted with hydrogen sulphide in the presence of an adduct of a Lewis acid such as BF₃ and a Lewis base such as n-butyl ether. When the specific triisobutene feedstock contaminated with Lewis bases is used, 2,2,4,6,6-pentamethylheptane-4-thiol is obtained in a yield of 32%. 62% of the triisobutene remains unreacted. The reaction times are again too long for an industrial reaction and are 6 hours.

When a C₁₂ feedstock based on tetrameric propene (tetrapropylene or tetrapropene) is used, various reaction conditions are employed for the addition of hydrogen sulphide, as can be seen from the scientific and patent literature cited below.

In Chemical Engineering Progress, Vol 59, no. 7, 1963, 68-73, results of systematic work on the addition of hydrogen sulphide onto a tetrapropene feedstock are examined. The process is carried out at from 1200F to 160° F. (from 49 to 71° C.) in the presence of gaseous boron trifluoride as catalyst. What influence if any the water content has on the result of the reaction is not described. It is stated that the quality of various tetrapropene feedstocks has a strong influence on the yields.

According to FR 2,094,239, a tetrapropene feedstock is reacted with hydrogen sulphide at atmospheric pressure and temperatures of from −5 to +5° C. in a continuous process. The reaction of hydrogen sulphide results in a thioether as by-product in the high-boiling fraction and the aluminium trichloride used as catalyst is dissolved in this. The tetrapropene conversions per reaction cycle are about 90%. Disadvantages of the process are large amounts of catalyst (170 g of AlCl₃ per 10 l of tetrapropene, corresponding to about 1.12 mol %) and residence times of 2 hours.

According to EP-A-0 329 521, the mercaptan addition onto tetrapropylene or triisobutylene is carried out continuously in the temperature range from 0° C. to 35° C. at a pressure of from 1 to 10 bar using polymer-immobilized sulphonic acids, with preference being given to dried cation exchange resins and copolymers of tetrafluoroethylene containing perfluorosulphonic acid. When a triisobutene feedstock is used, only from 50.7% to 43.6% of the triisobutene is reacted in one reaction cycle at 10 bar in the temperature range from 10 to 45° C. Nothing is said about the catalyst operating lives.

U.S. Pat. No. 2,951,875 describes the addition of hydrogen sulphide onto propylene homopolymers or oligomers. Depolymerization of propylene oligomers can be avoided by working at temperatures in the range from 25 to 100° C. in the presence of an activated Al₂O₃/SiO₂ catalyst.

According to U.S. Pat. No. 4,102,931, tert-mercaptan mixtures can be prepared by reaction of a tetrapropene feedstock with hydrogen sulphide in the presence of synthetic zeolites. The operating life of this catalyst is dependent on the residual moisture content of the raw materials used. The hydrogen sulphide is reacted continuously with a tetrapropene feedstock in a molar ratio of 10/1 at from 85 to 95° C. and 9 bar with the aid of a synthetically prepared zeolite. When dried hydrogen sulphide and dry tetrapropene are used, the olefin conversions in a single pass are >90%. In practice, the operating life of the specific catalyst is greatly dependent on the residual moisture content of the raw materials used. If moisture gets in, the plant has to be shut down in order to regenerate the catalyst by heat treatment at 240° C. The regeneration temperature for the catalyst is significantly lower than in the case of aluminium silicates presented as prior an (500° C.). U.S. Pat. No. 4,102,931 gives no information about the residence times at which the high olefin conversions are achieved. It is also not made clear whether the results can be applied to triisobutene.

According to EP-A-0 101 356, the addition of hydrogen sulphide onto tetrapropene is carried out continuously at a temperature of from 45 to 75° C. and a pressure of from 10 to 16 bar. The water content of the cation exchange resin has to be less than 0.5% by weight, which is achieved by drying at 80° C. for 6 hours. When a resin containing 1.6% by weight of water is used, the tetrapropene conversion is reduced from 90% to 80%. No information is given about the isomer distribution in the tert-dodecyl mercaptan mixture obtained. It is also not made clear whether the yields also apply to a triisobutene feedstock. The suitability of such a tert-dodecyl mercaptan mixture as regulator in rubber production is also not mentioned.

WO-A-2005/030710 describes the catalytic preparation of tert-dodecyl mercaptan by addition of hydrogen sulphide onto a specific olefin mixture based on a hexene dimer. This olefin mixture obtained by nickel-catalyzed dimerization of hexene comprises at least 10-18% by weight of olefin derived from n-dodecane, 25-40% by weight of olefin derived from 5-methyl-n-undecane, 25-40% by weight of olefin derived from 4-ethyl-n-decane, 2-78% by weight of olefin derived from 5,6-dimethyl-n-decane, 5-12% by weight of olefin derived from 5-ethyl-6-methyl-n-nonane, 1-5% by weight of olefin derived from 4,5-diethyl-n-octane and not more than 5% by weight of other hydrocarbons. As background to this specific synthesis, it is stated that polymer dispersions based on the known tert-dodecyl mercaptan frequently have an unpleasant odour and that the odour is generally stronger in the case of tert-dodecyl mercaptan prepared from trimeric isobutene than when tert-dodecyl mercaptan prepared from tetrameric propene is used. The mercaptan mixture obtained according to WO-A-2005/030710 is said to make it possible to reduce the intrinsic odour of emulsion polymers based on butadiene, styrene and acrylonitrile. The polymerization is carried out at from 85 to 95° C. WO-A-2005/030710 does not indicate whether the particular mercaptan mixture is suitable for adjusting the molecular weight in the cold polymerization of NBR.

The abovementioned literature references describe the addition of hydrogen sulphide onto various C₁₂ olefin feedstocks under a variety of process conditions. Many further possible influencing parameters are mentioned, e.g. type and composition of impurities, type and amount of catalyst and of additives or cocatalysts, type and amount of solvents, reaction conditions (temperature, pressure and reaction time), type of process and also the way of stopping and ending the reaction. In many cases, the composition of the olefin mixture/feedstock used remains unclear and terminology is frequently not precise. The composition of the mercaptan mixtures obtained is also not examined, nor is the question of a relationship between the various influencing parameters and the composition of the mercaptan mixtures obtained. Furthermore, the question of whether these mercaptans can be used as molecular weight regulators is not addressed in most cases.

### SUMMARY OF THE INVENTION

It was an object of the present invention to provide an improved process by means of which it is possible to obtain a mercaptan mixture which can be prepared on the basis of commercially available olefin mixtures and allows excellent regulation of the molecular weight in the production of rubbers, in particular nitrile rubbers, even when small amounts are used.

It has surprisingly been found to be possible to prepare a novel mercaptan mixture having a specific composition which fulfils the abovementioned requirements by means of a particular preparative process.

### DETAILED DESCRIPTION OF THE INVENTION

The present invention accordingly provides a process for preparing a mixture containing
2,2,4,6,6-pentamethylheptane-4-thiol,
2,4,4,6,6-pentamethylheptane-2-thiol,
2,3,4,6,6-pentamethylheptane-2-thiol and
2,3,4,6,6-pentamethylheptane-3-thiol,
   comprising reacting hydrogen sulphide with triisobutene at temperatures of from 0° C. to −60° C. in a continuous process in which
(a) the hydrogen sulphide is subjected to drying before the reaction,
(b) the triisobutene used has a water content of not more than 70 ppm,
(c) boron trifluoride is used as catalyst in amounts of not more than 1.5% by weight, based on the triisobutene used,
(d) the reaction is carried out in the absence of compounds which form complexes with boron trifluoride and
(e) the reaction mixture is brought into contact with an aqueous alkaline solution after the reaction to remove the catalyst.

The present invention further provides a mixture containing
2,2,4,6,6-pentamethylheptane-4-thiol,
2,4,4,6,6-pentamethylheptane-2-thiol,
2,3,4,6,6-pentamethylheptane-2-thiol and
2,3,4,6,6-pentamethylheptane-3-thiol.

The invention further provides for the use of the mixture according to the invention for regulating the molecular weight in polymerizations for producing rubbers, in particular for producing nitrile rubbers.

The invention likewise provides a rubber, in particular a nitrile rubber, which can be obtained by polymerization in the presence of the mixture of the invention and contains 2,2,4,6,6-pentamethylheptan-4-thio and/or 2,4,4,6,6-pentamethylheptane-2-thio and/or 2,3,4,6,6-pentamethylheptane-2-thio and/or 2,3,4,6,6-pentamethylheptane-3-thio end groups.

### Preparation of the Mercaptan Mixture of the Invention

Despite the long history and the variety of ways of preparing mixtures of tert-dodecyl mercaptans, the present invention has for the first time found the critical influencing factors which when simultaneously adhered to allow clear control of the composition and quality of the mixture of the invention.

Among these is a water content of not more than 70 ppm in the triisobutene used. This water content is preferably not more than 50 ppm, particularly preferably less than 50 ppm and very particularly preferably not more than 40 ppm. If the triisobutene feedstock does not already have this water content, the water content is adjusted before the reaction with hydrogen sulphide. This setting of the water content can be achieved, for example, by distillation or by bringing the triisobutene into contact with molecular sieves or zeolites. The determination of the water content can be carried out by the Karl-Fischer titration known to those skilled in the art.

The triisobutene (“TIB”) used for the reaction with hydrogen sulphide contains the four isomers
1) 2,2,4,6,6-pentamethyl-3-heptene,
2) 2-(2,2-dimethylpropyl)-4,4-dimethyl-1-pentene,
3) 2,4,4,6,6-pentamethyl-2-heptene and
4) 2,4,4,6,6-pentamethyl-1-heptene.

These isomers whose structural formulae are shown below can be identified by known analytical methods, e.g. by NMR or by means of gas-chromatographic separation in combination with mass spectroscopy.

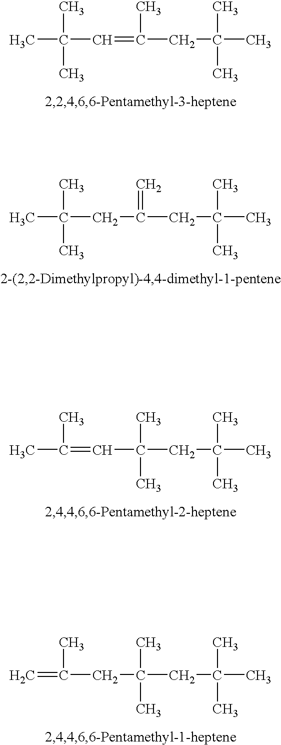

Apart from these four isomers, the triisobutene used usually contains some amounts of further constituents.

The triisobutene usually contains the four isomers in the following amounts:

from 45 to 55% by weight of 2,2,4,6,6-pentamethyl-3-heptene,
from 30 to 40% by weight of 2-(2,2-dimethylpropyl)-4,4-dimethyl-1-pentene,
from 1 to 5% by weight of 2,4,4,6,6-pentamethyl-2-heptene,
from 1 to 5% by weight of 2,4,4,6,6-pentamethyl-1-heptene and additionally
from 5 to 15% by weight of further constituents,
with all the abovementioned components having to add up to 100% by weight.

The triisobutene can be prepared using methods known to those skilled in the art by control of the process parameters as described for example in DE 1 199 761 B, with, for example, a cation exchanger in protonated form being used as catalyst for the oligomerization. Separate care has to be taken to ensure the specific water content of the triisobutene, as described above.

The hydrogen sulphide used for the reaction according to the invention is preferably prepared by in-situ reaction of commercially available sodium hydrogensulphide with sulphuric acid which is entrained in the preparation and can, for example, be removed by means of a water scrub.

It is also important in terms of the composition and quality of the mixture of the invention that the hydrogen sulphide used is subjected to drying before the reaction according to the invention. In this way, the water is removed from the hydrogen sulphide. Drying is carried out, for example, by cryostatic removal of the water present in the hydrogen sulphide. For this purpose, the water present in the hydrogen sulphide is, for example, condensed out in a first stage by cooling to temperatures in the range from −10° C. to 30° C., preferably in the range from 0° C. to 20° C., particularly preferably in the range from 3° C. to 18° C. and in particular in the range from 10° C. to 15° C. In the second stage, the hydrogen sulphide is cooled again to a temperature in the range from −15° C. to −50° C., preferably in the range from −10° C. to −25° C. Here, the remaining water present in the hydrogen sulphide is frozen out. The efficiency of the removal of water has a direct effect on the use of BF₃ in the hydrogen sulphide addition reaction, i.e. a high catalyst efficiency is achieved as a result. It is within the scope of the invention to use hydrogen sulphide which has been procured commercially in appropriately dry form i.e. in a form which has been freed of water, in the process of the invention.

Before addition of the catalyst, hydrogen sulphide is mixed in liquid form with the triisobutene and cooled. The molar ratio of hydrogen sulphide to triisobutene is in the range (1.1-10.0):1, preferably in the range (1.1-5.0):1, particularly preferably in the range (1.1-3.0):1 and in particular in the range (1.2-2.8):1, in the process of the invention.

The temperature of the mixture of hydrogen sulphide and triiusobutene before addition of the catalyst is in the range from −50° C. to 0° C., preferably in the range from −40° C. to −30° C. and particularly preferably in the range from −35 to −25° C.

Boron trifluoride is used for catalysis. It has been found to be useful to use boron trifluoride having a purity of at least 98%, preferably >98%, particularly preferably >99%. Boron trifluoride should be used without addition of compounds or additives which form complexes with boron trifluoride. Such additives include compounds which, for example, also function as solvents or as cocatalysts. These include, for example, ethers in the form of dialkyl ethers such as diethyl ether or in the form of alkyl aryl ethers such as phenetole or anisole or aromatic compounds such as toluene or benzene. The boron trifluoride is introduced in gaseous form, usually at a gauge pressure in the range from 5 to 10 bar, preferably in the range from 7 to 8 bar.

The amount of boron trifluoride based on the triisobutene used is not more than 1.5% by weight, preferably from 0.25 to 1.2% by weight, particularly preferably from 0.5 to 1.0% by weight, in particular from 0.6 to 0.9% by weight and very particularly preferably from 0.65 to 0.85% by weight.

The process of the invention is carried out in a temperature range from −10° C. to −60° C.

The catalytic addition of hydrogen sulphide onto triisobutene is carried out continuously. It is preferably carried out in a tube reactor or in two tube reactors connected in series. Particular preference is given to two tube reactors connected in series.

The length/diameter ratio of the first tube reactor is usually (5-20):1, preferably 10:1. The residence times in this reactor are usually from 0.5 to 5 minutes, preferably from 1 to 3 minutes. The temperature at the inlet of the 1^{st} reactor is usually in the range from −25° C. to −35° C. and preferably in the range from −27.5° C. to −32.5°. An average value of about −30° C. has been found to be useful. The heat of reaction evolved in this first reactor is removed by means of external cooling. Preference is given to evaporative cooling by means of vaporizing hydrogen sulphide which is recirculated to the reaction mixture.

The length/diameter ratio of the second tube reactor is usually (100-200):1, preferably (120-180):1. This tube reactor has, for example, a helical shape and can be cooled. The residence times in this reactor are usually in the range from 0.5 to 5 minutes, preferably in the range from 1 to 3 minutes. The temperature of the reaction mixture on entering the second tube reactor is in the range from −30° C. to 0° C., preferably in the range from −25° C. to −5° C., and the outlet temperature is from −40° C. to −60° C.

After the reaction is complete, the reaction mixture is brought into contact with an aqueous, alkaline solution. It has been found to be useful to pass the reaction mixture into this aqueous, alkaline solution. The aqueous alkaline solution has a temperature in the range from 10° C. to 100° C., preferably in the range from 30° C. to 90° C. and in particular in the range from 50° C. to 80° C.

The aqueous solution is preferably an aqueous solution containing ammonia, amines, hydroxides, hydrogencarbonates or carbonates in dissolved form. Particularly preferred examples are ammonia, sodium hydroxide, potassium hydroxide, sodium carbonate, potassium carbonate, sodium hydrogencarbonate and potassium hydrogencarbonate. Very particular preference is given to sodium hydroxide and potassium hydroxide. The concentration of this aqueous alkaline solution is up to 20% by weight, preferably from 1 to 10% by weight, particularly preferably from 3 to 5% by weight. As a result of the contact between reaction mixture and the aqueous alkaline solution, the reaction is stopped and the boron trifluoride catalyst is removed from the reaction mixture by extraction.

During the contact between reaction mixture and aqueous alkaline solution, the temperature is kept in the range from 10° C. to 100° C., preferably in the range from 30° C. to 90° C. and in particular in the range from 50° C. to 80° C., e.g. by introduction of steam which allows removal of the unreacted hydrogen sulphide by stripping. This unreacted hydrogen sulphide can, if desired, be recirculated to the reaction according to the invention.

After the above-described termination/extraction and stripping step, the crude mercaptan mixture according to the invention can be separated off continuously from the aqueous alkaline solution by means of a separator (mixer-settler) which exploits the density differences.

If desired, the crude mixture is washed one or more times with deionized water.

Unreacted triisobutene and high boilers can be separated off from the crude mixture by continuous fractional distillation. This distillation is preferably carried out under reduced pressure in a multistage column.

After one reaction cycle of the reaction according to the invention, the conversion of triisobutene is from 75 to 90%, preferably from 80 to 85%.

Unreacted triisobutene is separated off, collected and can be reacted once more under the above-described conditions in a second reaction cycle. In the 2^{nd} pass, from 60% to 70%, preferably from 63 to 65%, of the triisobutene used is reacted.

The total triisobutene conversion after 1^{st} and 2^{nd} reaction passes is from 85 to 99%, preferably from 87 to 97%.

The total yield of mixture purified by distillation after 2 reaction passes is 92±5% based on the triisobutene used.

If two reaction passes are carried out, the mixtures according to the invention from the 1^{st} and 2^{nd} reaction passes can be combined.

The mixture of the invention contains
2,2,4,6,6-pentamethylheptane-4-thiol,
2,4,4,6,6-pentamethylheptane-2-thiol,
2,3,4,6,6-pentamethylheptane-2-thiol and
2,3,4,6,6-pentamethylheptane-3-thiol
   whose formulae are shown below.

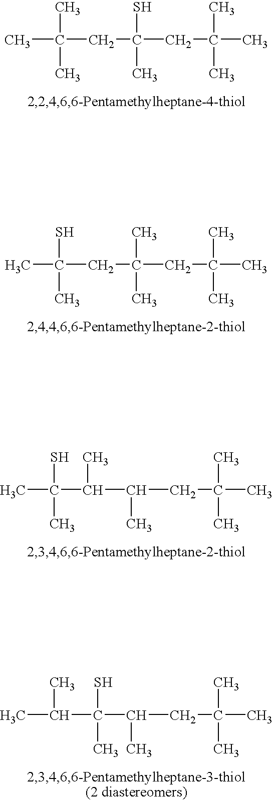

Assignment of the chemical structural formulae to the individual fractions obtained by gas chromatography is effected by means of mass spectrometry.

Gas chromatography is carried out using an FID. In practice, it is usual to dilute 50 μl in each case of the mixture according to the invention with 5 ml of toluene and analyze 0.2 μl of this solution by gas chromatography. The following conditions are employed for carrying out the analyses:

| | |
|---|---|
| Gas chromatograph: | Fison Trace GC |
| Separation column: | Stabilwax-DB (Restek) |
| | 30 m, 0.25 mm ID, 0.25 μm df |
| Detector temperature: | 260° C. |
| Injector temperature: | 170° C. |
| Oven temperature: | 60° C., 2 min isothermal |
| | heating rate: 5° C./min |
| | 190° C. final temperature, 1 min isothermal |
| Carrier gas: | helium, 1.0 ml flow through the column |
| Split: | 50 ml/min |

The chemical structure of the fractions of the isomer mixture according to the invention which had been separated by means of gas chromatography was subsequently determined by mass spectroscopy.

Based on this analysis, the mixture of the invention preferably comprises:
70-85% by area, particularly preferably 75-83% by area of 2,2,4,6,6-pentamethylheptane-4-thiol,
3-6% by area, particularly preferably 4-5.5% by area of 2,4,4,6,6-pentamethylheptane-2-thiol,
2-5% by area, particularly preferably 3-4.5% by area of 2,3,4,6,6-pentamethylheptane-2-thiol,
3-13% by area, particularly preferably 3.5-12% by area of 2,3,4,6,6-pentamethylheptane-3-thiol
   and further compounds, with the sum of all isomers and Me further compounds being 100.

The mixture of the invention containing 2,2,4,6,6-pentamethylheptane-4-thiol, 2,4,4,6,6-pentamethylheptane-2-thiol, 2,3,4,6,6-pentamethylheptane-2-thiol and 2,3,4,6,6-pentamethyl-heptane-3-thiol can preferably be obtained by reaction of hydrogen suiphide with triisobutene at temperatures in the range from 0° C. to −60° C. in a continuous process in which
(a) the hydrogen sulphide is subjected to drying before the reaction,
(b) the triisobutene used has a water content of not more than 70 ppm,
(c) boron trifluoride is used as catalyst in amounts of not more than 1.5% by weight, based on the triisobutene used,
(d) the reaction is carried out in the absence of compounds which form complexes with boron trifluoride and
(e) the reaction mixture is brought into contact with an aqueous alkaline solution after the reaction to remove the catalyst.

The process of the invention has many advantages;
It can be carried out on the basis of a readily available triisobutene and gives a mixture which comprises the abovementioned four specific isomers.
The preparation is carried out in a very economical way in a continuous process with extremely short residence times and at the same time very low usages of catalyst of not more than 1.5% by weight, based on the triisobutene used. The reaction is happily carried out in the absence of additives which form complexes with the boron trifluoride used as catalyst and in the processes of the prior art represent further organic, frequently aromatic and thus undesirable constituents.
The mixture of the invention is obtained in high yields.

Furthermore, the mixture of the invention can be used very well for regulating the molecular weight in the production of synthetic rubbers, in particular in the production of nitrile rubbers. Only very small amounts are necessary to set the desired molecular weights.

The mixture of the invention is suitable for setting the molecular weight in the production of rubbers based on diolefins such as butadiene and, if appropriate, further copolymerizable monomers such as styrene, α-methylstyrene, vinylnaphthalene, acrylonitrile, methacrylonitrile, methyl methacrylate, ethyl fumarate or methyl vinyl ketone, in particular by emulsion polymerization.

The mixture of the invention is preferably used for setting the molecular weight in the production of nitrile rubbers. Monomers used here are at least one α,β-unsaturated nitrile, at least one conjugated diene and, if appropriate, one or more further copolymerizable monomers.

The conjugated diene can be of any nature. Preference is given to using (C₄-C₆) conjugated dienes. Particular preference is given to 1,3-butadiene, isoprene, 2,3-dimethylbutadiene, piperylene, 1,3-pentadiene or any mixtures thereof. 1,3-Butadiene and isoprene or mixtures thereof are especially preferred. Very particular preference is given to 1,3-butadiene.

As α,β-unsaturated nitrile, it is possible to use any known α,β-unsaturated nitrile, with preference being given to (C₃-C₅)-α,β-unsaturated nitrites such as acrylonitrile, methacrylonitrile, 1-chloroacrylonitrile, ethacrylonitrile or mixtures thereof. Particular preference is given to acrylonitrile.

A nitrile rubber which can be particularly preferably produced using the mercaptan mixture of the invention is thus a copolymer of acrylonitrile and 1,3-butadiene.

Apart from the conjugated diene and the α,β-unsaturated nitrile, it is also possible to use one or more further copolymerizable monomers known to those skilled in the art, e.g. α,β-unsaturated monocarboxylic or dicarboxylic acids, their esters or amides. Such nitrile rubbers are usually referred to as carboxylated nitrile rubbers or “XNBR” for short.

As α,β-unsaturated monocarboxylic or dicarhoxylic acids, it is possible to use, for example, fumaric acid, maleic acid, acrylic acid, methacrylic acid, crotonic acid and itaconic acid. Preference is given to maleic acid, acrylic acid, methacrylic acid and itaconic acid.

As esters of α,β-unsaturated carboxylic acids, use is made of, for example, alkyl esters, alkoxyalkyl esters, hydroxyalkyl esters or mixtures thereof.

Particularly preferred alkyl esters of α,β-unsaturated carboxylic acids are methyl (meth)acrylate, ethyl(meth)acrylate, propyl(meth)acrylate, n-butyl(meth)acrylate, t-butyl (meth)acrylate, hexyl(meth)acrylate, 2-ethylhexyl(meth)acrylate, octyl(meth)acrylate and lauryl(meth)acrylate. Very particular preference is given to using n-butyl acrylate.

Particularly preferred alkoxyalkyl esters of α,β-unsaturated carboxylic acids are methoxyethyl (meth)acrylate, ethoxyethyl(meth)acrylate and methoxyethyl(meth)acrylate. Particular preference is given to using methoxyethyl acrylate.

Particularly preferred hydroxyalkyl esters of α,β-unsaturated carboxylic acids are hydroxyethyl(meth)acrylate, hydroxypropyl(meth)acrylate and hydroxybutyl(meth)acrylate.

Further esters of α,β-unsaturated carboxylic acids which can be used are, for example, polyethylene glycol (meth)acrylate, polypropylene glycol (meth)acrylate, glycidyl (meth)acrylate, epoxy(meth)acrylate and urethane (meth)acrylate.

Other possible monomers are vinylaromatics such as styrene, a-methylstyrene and vinylpyridine.

The proportions of conjugated diene and α,β-unsaturated nitrite can be varied within wide ranges for the production of the nitrite rubbers. The proportion of the conjugated diene or of the sum of conjugated dienes is usually in the range from 20 to 95% by weight, preferably in the range from 40 to 90% by weight, particularly preferably in the range from 60 to 85% by weight, based on the total polymer. The proportion of the α,β-unsaturated nitrile or of the sum of α,β-unsaturated nitrites is usually from 5 to 80% by weight, preferably from 10 to 60% by weight, particularly preferably from 15 to 40% by weight, based on the total polymer. The proportions of the monomers in each case add up to 100% by weight.

The additional monomers can be used in amounts of from 0 to 40% by weight. Amounts of from 0.1 to 40% by weight, preferably from 1 to 30% by weight, based on the sum of the monomers, are possible. In this case, corresponding proportions of the conjugated diene or dienes and/or of the α,β-unsaturated nitrile or nitrites are replaced by the proportions of these additional monomers, with the proportions of all monomers continuing to add up to 100% by weight in each case.

If esters of (meth)acrylic acid are used as additional monomers, they are usually used in amounts of from 1 to 25% by weight.

If α,β-unsaturated monocarboxylic or dicarboxylic acids are used as additional monomers, they are usually used in amounts of less than 10% by weight.

The process for producing the rubbers can be carried out by methods known to those skilled in the art. Nitrite rubbers are usually produced by emulsion polymerization.

The nitrogen content of the nitrite rubbers obtained in this way is determined by the Kjeldahl method in accordance with DIN 53 625. Owing to the content of polar comonomers, the nitrite rubbers are usually soluble in methyl ethyl ketone to an extent of ≧85% by weight at 20° C.

The nitrite rubbers which can be produced in this way have Mooney viscosities (ML 1+4@100° C.) in the range from 10 to 150, preferably from 20 to 100, Mooney units. The Mooney viscosity (ML 1+4@100° C.) is determined at 100° C. by means of a shear disc viscometer in accordance with DIN 53523/3 or ASTM D 1646.

The glass transition temperatures of the nitrite rubbers are in the range from −70° C. to +10° C., preferably in the range from −60° C. to 0° C.

Owing to its function as molecular weight regulator, the mixture of the invention is to a certain extent present in the form of end groups in the rubbers produced in the polymerization, in particular the nitrite rubbers. This means that the nitrite rubber has 2,2,4,6,6-pentamethylheptane-4-thio and/or 2,4,4,6,6-pentamethylheptane-2-thio and/or 2,3,4,6,6-pentamethylheptane-2-thio and/or 2,3,4,6,6-pentamethylheptane-3-thio end groups.

### EXAMPLES

### Materials Used

Triisobutene (TIB) is a trimerized isobutene and is procured from INEOS, Germany. TIB has a boiling range of 174-189° C., an index of refraction of n_{D}²⁰ of 1.4367, a sulphur content of <5 ppm and a peroxide content, determined as H₂O₂, of <5 ppm. The water content is 37 ppm.

It comprises:

48% by weight of 2,2,4,6,6-pentamethyl-3-heptene,
33% by weight of 2-(2,2-dimethylpropane)-4,4-dimethyl-1-pentene,
3% by weight of 2,4,4,6,6-pentamethyl-2-heptene and
2% by weight of 2,4,4,6,6-pentamethyl-1-heptene and also
14% by weight of further compounds.

Hydrogen sulphide is prepared continuously in an amount of 200 kg/h by reaction of an aqueous solution (39-40% strength by weight) of sodium hydrogensulphide (supplier: Carbosulf Akzo Nobel) with sulphuric acid (70% strength) at a temperature of 55-65° C. and a pressure of 2 bar. Entrained sulphuric acid is scrubbed out by means of 5% strength sodium hydroxide solution in a jet scrubber. Before liquefaction of the hydrogen sulphide, water is condensed out by cooling to 15° C. and frozen out by cooling to −20° C.

Boron trifluoride: gaseous; supplier: BASE/Arkema; purity: >99.5%.

### A Continuous Preparation of the Mixture According to the Invention

### Example 1

The hydrogen sulphide which had been prepared and dried as described above was mixed with TIB which had been precooled to −20° C. in a molar ratio of 2.71:1, compressed to 3 bar and cooled and liquefied in 2 stages at −10° C. and −30° C.

Boron trifluoride was subsequently passed in an amount of 0.64% by weight, based on the TIB used, at a pressure of 8 bar into the mixture of TIB and hydrogen sulphide which had been cooled to −30° C. The reaction took place in two tube reactors connected in series. The residence time in the first tube reactor (volume: 11 l; length/diameter ratio: 9/1) was about 1 minute. The reaction mixture was subsequently fed into a helical tube reactor (volume: 16 l, length/diameter ratio: 166/1; residence time: about 1.5 minutes) which had been cooled in countercurrent by means of brine to −60° C. The temperature at which the reaction mixture entered was −15±1° C., and the temperature at the outlet at the end of the helical tube was −45±2° C.

To stop the reaction, the reaction mixture was conveyed via an immersed tube into a stopping vessel into which an aqueous sodium hydroxide solution (5%) was fed continuously. In this way, the catalyst was destroyed and scrubbed out as sodium borate and sodium fluoride. The temperature in the stopping vessel was maintained at 50° C. by introduction of steam and unreacted hydrogen sulphide was stripped out at the same time.

The stopped reaction mixture was fed continuously into a separator in which the organic phase of crude mercaptan (crude TDDM) was separated off as upper phase from the aqueous phase at 40° C. Before the distillation, the crude TDDM was washed with deionized water. To remove residual amounts of hydrogen sulphide, the crude mercaptan was treated at 65° C./80 mbar.

The desired pure mercaptan fraction was separated off from high molecular weight high boilers and unreacted TIB by means of a continuous fractional distillation under reduced pressure in a column packed with Raschig rings. In continuous operation, pure mercaptan having a density of 0.8625 g/cm³ was taken off as a side stream at a temperature at the bottom of 128-132° C. at 45 mbar and a temperature at the top of 74-76° C./40 mbar.

85% of the TIB was reacted in the 1^{st} reaction pass.

The unreacted TIB was collected and reacted again with hydrogen sulphide in a 2^{nd} pass. 63% of the TIB was reacted in the second reaction pass.

A total triisobutene conversion of 94.5% was thus obtained.

After two reaction passes, the yield of mercaptan mixture purified by distillation was 94.5% based on TIB reacted. The composition of the mixture obtained is shown in Table 1 (No. 1).

### Examples 2-6

Examples 2 to 6 were carried out in a manner analogous to Example 1 but different TIB batches having different water contents were used. The water content is shown in Table 1, as are the results obtained.

In the following table, the individual constituents of the inventive mixture obtained are abbreviated as follows:

| | |
|---|---|
| 2,2,4,6,6-pentamethylheptane-4-thiol: | Isomer 1 |
| 2,4,4,6,6-pentamethylheptane-2-thiol: | Isomer 2 |
| 2,3,4,6,6-pentamethylheptane-2-thiol: | Isomer 3 |
| 2,3,4,6,6-pentamethylheptane-3-thiol: | Isomer 4 and 4′, since two |
| | diastereomers are present. |

TABLE 1
Results of Examples 1-6

| | | | TIB | Total | | | | | | |
|---|---|---|---|---|---|---|---|---|---|---|
| | Water | TIB | conversion | yield | | | | | | |
| | content | conversion | (after | (after | | | | | | |
| | of the | (after 1st | two | two | | | | | | |
| | TIB | reaction | reaction | reaction | | | | | Isomer | Further |
| | used | cycle) | cycles) | cycles) | Isomer 1 | Isomer 2 | Isomer 3 | Isomer 4 | 4′ | constituents |
| Ex. | [ppm] | [%] | [%] | [%] | [%] | [%] | [%] | [%] | [%] | [%] |
| 1 | 37 | 85 | 94.5 | 95 | 80.0 | 5.3 | 3.8 | 2.6 | 1.9 | 6.4 |
| 2 | 32 | 80 | 93 | 92 | 80.4 | 5.4 | 3.8 | 3.3 | 1.4 | 5.7 |
| 3 | 30 | 82 | 93.4 | 93 | 80.1 | 5.4 | 3.8 | 3.3 | 1.2 | 6.2 |
| 4 | 38 | 81 | 93.4 | 93 | 79.2 | 5.7 | 4.0 | 3.5 | 0.8 | 6.8 |
| 5 | 35 | 80 | 92.6 | 92 | 81.6 | 5.0 | 4.1 | 3.0 | 1.1 | 5.2 |
| 6 | 29 | 83 | 93.7 | 92 | 79.4 | 5.4 | 4.2 | 3.4 | 1.4 | 6.2 |

It can be seen from Table 1 that the composition of the inventive mercaptan mixture obtained after the 1^{st} and 2^{nd} reaction passes varies within a very narrow range when the reaction is repeated using different triisobutene hatches. This is a considerable advantage.

### Gas-Chromatographic Separation of the Isomer Mixture According to the Invention and Mass-Spectroscopic Elucidation of the Structure of the Isomers:

The composition of the isomer mixtures obtained in Examples 1-6 was determined by means of gas chromatography using an FID. For the analysis, 50 μl in each case of the reaction products obtained from Examples 1-6 were diluted with 5 ml of toluene, and 0.2 μl of this solution was in each case analyzed by gas chromatography. The following conditions were employed for carrying out the analyses:

| | |
|---|---|
| Gas chromatograph: | Fison Trace GC |
| Separation column: | Stabilwax-DB (Restek) |
| | 30 m, 0.25 mm ID, 0.25 μm df |
| Detector temperature: | 260° C. |
| Injector temperature: | 170° C. |
| Oven temperature: | 60° C., 2 min isothermal |
| | heating rate: 5° C./min |
| | 190° C. final temperature, 1 min isothermal |
| Carrier gas: | helium, 1.0 ml column flow |
| Split: | 50 ml/min |

The chemical structure of the fractions of the isomer mixture obtained which had been separated by means of gas chromatography was subsequently determined by mass spectroscopy. This is shown below for the isomer mixture from Example 1. The corresponding mass spectra of the individual fractions are shown in the following figure.

Peaks having characteristic m/e ratios occur in the mass spectra:
159 arises as a result of elimination of a propyl radical (m/e=43) from the radical molecular ion (m/e=202)
113 arises as a result of elimination of a sulphur-containing radical (m/e=89) from the radical molecular ion (m/e=202)
103 arises as a result of elimination of a C₇H₁₅ radical (m/e=99) from the radical molecular ion having an m/e of 202 or as a result of elimination of isobutene (m/e=56) from m/e=159
97 arises as a result of elimination of H₂S (m/e=34) from m/e=131 or as a result of elimination of an ethyl radical (me=29) from m/e=126
89 arises as a result of elimination of m/e=113 from be radical molecular ion having an m/e of 202
75 arises as a result of elimination of C₉H₁₉ (m/e=127) from the radical molecular ion (m/e=202)
69 is a C₅H₉ cation arising as a result of elimination of H₂S (m/e=34) from m/e=103
57 is the tert-butyl cation (C₄H₉)
41 is the propyl cation (C₃H₅).

The assignments were made on the basis of the following literature references:
H. Budzikiewicz, C. Djerassi, D. H. Williams, Mass Spectrometry of Organic Compounds, Holden-Day Inc., San Francisco, 1967.
J. H. Gross, Mass Spectrometry, Springer-Verlag, Heidelberg, 2004.

### B Production of Nitrile Rubber Using the Isomer Mixture of the Invention

The nitrile rubber was produced using the starting materials indicated in Table 2, with all formulation constituents being reported in parts by weight and being based on 100 parts by weight of the monomer mixture. Table 2 also shows the other polymerization parameters.

TABLE 2

| | Examples according to the invention | | |
|---|---|---|---|
| | 7 | 8 | 9 |
| Butadiene (parts by weight) | 73 | 73 | 73 |
| Acrylonitrile (parts by weight) | 27 | 27 | 27 |
| Total amount of water | 200 | 200 | 200 |
| Erkantol ® BXG¹⁾ | 3.69 | 3.69 | 3.69 |
| Baykanol ® PQ²⁾ | 1.10 | 1.10 | 1.10 |
| K salt of coconut fatty acid | 0.72 | 0.72 | 0.72 |
| KOH | 0.05 | 0.05 | 0.05 |
| Mixture according to the invention from | 0.21^{3a)}/0.21^{3b)} | 0.23^{3a)}/0.23^{3b)} | 0.25^{3a)}/0.24^{3b)} |
| Example 1 | | | |
| Potassium peroxodisulphate | 0.39^{4a)}/0.20^{4b)} | 0.39^{4a)}/0.20^{4b)} | 0.39^{4a)}/0.20^{4b)} |
| Tris(α-hydroxyethyl)amine | 0.57 | 0.57 | 0.57 |
| Na dithionite | 1.28 | 1.28 | 1.28 |
| 2,6-Di-tert-butyl-p-cresol⁵⁾ | 1.25 | 1.25 | 1.25 |
| Polymerization temperature [° C.] | 13 | 13 | 13 |
| Polymerization conversion [%] | 66 | 68 | 70 |
| ACN content of the nitrile rubber | 27.9 | 27.1 | 26.8 |
| [% by weight] | | | |
| ML (1 + 4 @ 100° C.) of the nitrile | 139 | 82 | 40 |
| rubber [MU] | | | |

¹⁾Sodium salt of a mixture of monosulphonated and disulphonated naphthalenesulphonic acids having isobutylene oligomer substituents (Erkantol ® BXG)
²⁾Sodium salt of methylenebisnaphthalenesulphonate (Baykanol ® PQ, Lanxess Deutschland GmbH)
^{3a)}Parts by weight introduced before commencement of the polymerization
^{3b)}Further parts by weight introduced at 15% conversion
^{4a)}Parts by weight introduced before commencement of the polymerization
^{4b)}Further parts by weight introduced at 15% conversion
⁵⁾Vulkanox ® KB; Lanxess Deutschland GmbH

The polymerization was carried out batchwise in a 200 l autoclave provided with a stirrer. 35 kg of the monomer mixture and a total amount of water of 70 kg were used in each of the autoclave batches. Of this amount of water, 60 kg were in each case initially placed in the autoclave together with the emulsifiers (Erkantol® BXG, Baykanol® PQ and K salt of coconut fatty acid) and sodium hydroxide and flushed with a stream of nitrogen. Aqueous solutions of potassium peroxodisulphate, tris(α-hydroxyethyl)amine and sodium dithionite were prepared using the remaining amount of water. The destabilized monomers and the amounts indicated in Table 2) of the mercaptan mixture according to the invention from Example 1 were then added and the reactor was closed. After thermostating the contents of the reactor, the polymerizations were started by gradual addition of aqueous solutions of tris(α-hydroxyethyl)amine and of potassium peroxodisulphate (in the partial amounts indicated in each case). The course of the polymerization was followed by gravimetric determination of the conversion. At a polymerization conversion of 15%, the remaining amounts of the mixture according to the invention from Example 1 and of potassium peroxodisulphate were fed in. When a conversion of about 65-70% had been reached, the polymerization was stopped by addition of an aqueous solution of sodium dithionite and the mixture was admixed with a solution of Vulkanox® KB dissolved in a small amount of acrylonitrile. Unreacted monomers and other volatile constituents were removed by means of steam distillation.

To determine the Mooney viscosity, aliquots of the latices were coagulated by means of a calcium chloride solution. For this purpose, 3% by weight of calcium chloride based on nitrile rubber was used in each case. The coagulation was carried out in a stirrable vessel, with the aqueous calcium chloride solution (0.03% strength by weight) being initially placed in the vessel and heated to 70° C. The latex was slowly added to the precipitant solution while stirring. After coagulation, the rubber crumb was separated off by means of a sieve and washed by being redispersed twice in water at 70° C., subjected to preliminary dewatering to a residual moisture content of from 5 to 20% by weight by pressing and dried batchwise in a convection drying oven to a residual moisture content of <0.6%.

The Mooney viscosity (ML 1+4@100° C.) was determined at 100° C. by means of a shear disc viscometer in accordance with DIN 53523/3 or ASTM D 1646.

This trial shows that the use of the mercaptan mixture according to the invention allows targeted setting of Mooney viscosities in the range, for example, from 40 to 140 Mooney units and that only small amounts of the mercaptan mixture are necessary for setting the molecular weight.

What is claimed is:

1. A process for preparing a mixture containing
2,2,4,6,6-pentamethylheptane-4-thiol,
2,4,4,6,6-pentamethylheptane-2-thiol,
2,3,4,6,6-pentamethylheptane-2-thiol and
2,3,4,6,6-pentamethylheptane-3-thiol,
comprising reacting hydrogen sulphide with triisobutene at temperatures of from 0° C. to −60° C. in a continuous process, wherein
(a) the hydrogen sulphide is subjected to drying before the reaction,
(b) the triisobutene used has a water content of not more than 70 ppm,
(c) boron trifluoride is used as catalyst in amounts of not more than 1.5% by weight, based on the triisobutene used,
(d) the reaction is carried out in the absence of compounds which form complexes with boron trifluoride and
(e) the reaction mixture is brought into contact with an aqueous alkaline solution after the reaction to remove the catalyst.

2. The process according to claim 1, wherein the triisobutene has a water content of not more tan 50 ppm, preferably less tan 50 ppm and particularly preferably not more than 40 ppm.

3. The process according to claim 1, wherein the triisobutene (“TIB”) used for the reaction with hydrogen sulphide contains the four isomers
2,2,4,6,6-pentamethyl-3-heptene,
2-(2,2-dimethylpropyl)-4,4-dimethyl 1-pentene,
2,4,4,6,6-pentamethyl-2-heptene and
2,4,4,6,6-pentamethyl-1-heptene.

4. The process according to claim 1 wherein the triisobutene contains
from 45 to 55% by weight of 2,2,4,6,6-pentamethyl-3-heptene,
from 30 to 40% by weight of 2-(2,2-dimethylpropyl)-4,4-dimethyl 1-pentene,
from 1 to 5% by weight of 2,4,4,6,6-pentamethyl-2-heptene,
from 1 to 5% by weight of 2,4,4,6,6-pentamethyl-1-heptene and
from 5 to 15% by weight of further compounds,
with all the abovementioned components adding up to 100% by weight.

5. The process according to claim 3, wherein the triisobutene contains
from 45 to 55% by weight of 2,2,4,6,6-pentamethyl-3-heptene,
from 30 to 40% by weight of 2-(2,2-dimethylpropyl)-4,4-dimethyl-1-pentene,
from 1 to 5% by weight of 2,4,4,6,6-pentamethyl-2-heptene,
from 1 to 5% by weight of 2,4,4,6,6-pentamethyl-1-heptene and
from 5 to 15% by weight of further compounds,
with all the abovementioned components adding up to 100% by weight.

6. The process according to claim 1, wherein the hydrogen sulphide used is subjected to drying by, in a 1^{st} stage, the water present in the hydrogen sulphide being condensed out by cooling to a temperature in the range from −10° C. to 30° C., and in the 2^{nd} stage, the hydrogen sulphide being cooled again to a temperature in the range from −15° C. to −50° C. before the reaction.

7. The process according to claim 1, wherein the hydrogen sulphide is mixed in liquid form with the triisobutene and cooled before addition of the catalyst.

8. The process according to claim 1, wherein the molar ratio of hydrogen sulphide to triisobutene is in the range (1.1-10.0):1.

9. The process according to claim 7 or 8, wherein the temperature of the mixture of hydrogen sulphide and triisobutene before addition of the catalyst is in the range from −50° C. to 0° C.

10. The process according to claim 1, wherein the boron trifluoride is introduced in gaseous form at a gauge pressure in the range from 5 to 10 bar.

11. The process according to claim 1, wherein the amount of boron trifluoride based on the triisobutene used is from 0.25 to 1.2% by weight.

12. The process according to claim 1, wherein the reaction is carried out in a tube reactor or in two tube reactors connected in series.

13. The process according to claim 1, wherein the reaction is carried out in two tube reactors connected in series and the residence time in the first reactor is from 0.5 to 5 minutes and that in the second reactor is from 0.5 to 5 minutes.

14. The process according to claim 13, wherein the temperature of the reaction mixture on entering the second tube reactor is in the range from 0° C. to −30° C. and the outlet temperature is from −40° C. to −60° C.

15. The process according to claim 1, wherein the reaction mixture is passed into an aqueous alkaline solution after the reaction is complete.

16. The process according to claim 15, wherein the aqueous alkaline solution is an aqueous solution containing ammonia, amines, hydroxides, hydrogencarbonates or carbonates in dissolved form,

17. The process according to claim 15, wherein the aqueous alkaline solution is an aqueous solution containing sodium hydroxide, potassium hydroxide, sodium carbonate, potassium carbonate, sodium hydrogencarbonate or potassium hydrogencarbonate.

18. The process according to claim 16, wherein the temperature is kept in the range from 10° C. to 100° C. during the contact between the reaction mixture and the aqueous alkaline solution.

19. A mixture comprising 2,2,4,6,6-pentamethylheptane-4-thiol, 2,4,4,6,6-pentamethyl-heptane-2-thiol, 2,3,4,6,6-pentamethylheptane-2-thiol and 2,3,4,6,6-pentamethylheptane-3-thiol.

20. The mixture according to claim 19 which can be obtained by the process for preparing a mixture comprising
2,2,4,6,6-pentamethylheptane-4-thiol,
2,4,4,6,6-pentamethylheptane-2-thiol,
2,3,4,6,6-pentamethylheptane-2-thiol and
2,3,4,6,6-pentamethylheptane-3-thiol,
comprising reacting hydrogen sulphide with triisobutene at temperatures of from 0° C. to −60° C. in a continuous process, wherein
(a) the hydrogen sulphide is subjected to drying before the reaction,
(b) the triisobutene used has a water content of not more than 70 ppm,
(c) boron trifluoride is used as catalyst in amounts of not more than 1.5% by weight, based on the triisobutene used,
(d) the reaction is carried out in the absence of compounds which form complexes with boron trifluoride and
(e) the reaction mixture is brought into contact with an aqueous alkaline solution after the reaction to remove the catalyst.

21. A process for producing a nitrile rubber by polymerization of at least one α,β-unsaturated nitrite, at least one conjugated diene and optionally one or more further copolymerizable monomers in the presence of the mixture according to claim 19.

22. A nitrite rubber which can be obtained by the process according to claim 21.
